(19) United States
(12) Patent Application Publication
(10) Pub. No.: US 2008/0212233 A1
(43) Pub. Date: Sep. 4, 2008

(54) Method of manufacturing storage medium apparatus and storage medium apparatus

(75) Inventor: Yoshiyuki Nanba, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/006,705

(22) Filed: Jan. 4, 2008

(30) Foreign Application Priority Data
Feb. 2, 2007 (JP) 2007-024602

(51) Int. Cl. G11B 5/82; H01F 41/02; G11B 5/127

(52) U.S. Cl. 360/135; 29/604; 29/603.03; 29/603.1

(57) ABSTRACT

A method of manufacturing a storage medium apparatus having a storage medium that stores data. The method includes disposing the storage medium onto a first unit having an insertion section to be inserted into a through hole of the storage medium and an abutment face made of a soft-metal material and spreading around the insertion section, such that the abutment face abuts a surface of the storage medium. The method further includes: abutting an abutment face of a second unit, made of a soft-metal material, on a surface of the storage medium opposite to the surface abutting the abutment face of the first unit; and while holding the storage medium between the first unit and the second unit, fixing the storage medium and at least one of the first unit and the second unit by rotating the storage medium and the one relatively to each other about the through hole.

### BACKGROUND OF THE INVENTION

1. Field of the Invention

The present invention relates to a storage medium apparatus in which a storage medium for storing data is incorporated, and a method of manufacturing the same.

2. Description of the Related Art

In recent years, there have been rapidly developed, along with development in computer techniques, techniques involving devices incorporated in a computer or peripheral devices connected to a computer from the outside. As one of such techniques, there is known an apparatus such as a magnetic disk that is provided with a planar storage medium and is directed for writing information in the storage medium to store the information.

Some of the apparatuses for storing information using a storage medium make a head section for recording and reproducing information with respect to the storage medium closer to the surface of the storage medium while rotating the storage medium so as to record information into each storage area (track) on the storage medium or to reproduce information from each track. Since a storage medium provided in such an apparatus may be damaged from a member contacting with the storage medium at the time of the rotation of the storage medium, it may be provided at part of the storage medium surface with a protection film in order to avoid such a damage (For example, see Japanese Patent Application Publication No. 61-148686 Publication).

In the field of apparatuses for writing information into a storage medium to store the information, in recent years, there has been increased a demand for apparatuses which are provided with a storage medium having a higher recording density along with rapid development in computer techniques, and there has been increased the recording density of commercially-available storage mediums year after year.

Generally, as the recording density of the storage medium increases, it is required that the distance between the storage medium and the head section is made shorter for precise information recording/reproducing and further that the distance is kept constant at each point on the storage medium. However, when the apparatus is assembled in a state where foreign materials such as dusts are between the storage medium and a fixing member for fixing the storage medium on a rotation shaft, a distortion may occur in the storage medium where foreign materials exist. Since flatness of the storage medium is lost if such a distortion occurs, defect areas where information recording or reproducing is disabled appear near the distortion intensively. The concentration of the defect areas will be described by way of a case where the storage medium is a magnetic disk.

Generally, a magnetic disk is provided with a disk substrate having high intensity and hardness, an under layer for controlling recording characteristics of the magnetic disk and a magnetic layer for recording information are sequentially formed on the substrate and a protection layer for protecting the magnetic layer is further formed on the magnetic layer to serve as the disk surface. The disk substrate is made of a glass substrate having a thickness of 0.8 to 1 mm and the under layer and the magnetic layer are made of an alloy material having a thickness of about 5 to 20 nm. Further, the protection layer is made of a material such as diamond-like carbon (DLC) having a thickness of about 5 to 10 nm. A lubrication layer made of fluorinated lubricant such as perfluoro polyether is formed at a thickness of 1 to 2 nm on the protection layer in order to restrict wear caused by sliding of the head section.

FIG. 1 shows a distribution of defects of a substantially-flat magneticdisk, and FIG. 2 shows a distribution of defects of a magnetic disk in which a distortion occurs.

In FIGS. 1 and 2, there are shown by black points defect areas where information recording or reproducing is disabled in plane with the magnetic disk. For the substantially flat magnetic disk, as shown in FIG. 1, defect areas having a small area intend to appear in a distributed manner in plane with the magnetic disk. Although such defect areas occur due to small dusts, since each defect area is remarkably small, in fact, the defect areas will not cause damages for information recording or reproducing. On the other hand, in the magnetic disk where a distortion occurs as shown in FIG. 2, defect areas intensively appear in the region A surrounded by a dotted line. This is a characteristic phenomenon that appears when a distortion occurs in the magnetic disk in the region A. When the defect areas concentrate on the region A, they are recognized as a distinguished failure by a user when information is recorded or reproduced.

### SUMMARY OF THE INVENTION

The present invention has been made in view of the above circumstances and provides a storage medium apparatus, in which a distortion is prevented from occurring in a storage medium, which is provided with the storage medium such as a drive member for rotating and driving the provided storage medium or a casing in which the rotation drive member provided with the storage medium is accommodated, and a method of manufacturing the same.

The present invention provides a method of manufacturing a storage medium apparatus in which a storage medium which stores data is incorporated according to a first aspect, including the steps of:

disposing the storage medium onto a first unit having an insertion section to be inserted into a through hole of the storage medium and an abutment face made of a soft metal material and spreading around the insertion section, such that the insertion section is inserted into the through hole of the storage medium and the abutment face abuts on a surface of the storage medium;

abutting an abutment face of a second unit on a surface of the storage medium opposite to the surface abutting the abutment face of the first unit, the abutment face of the second unit being made of a soft metal material; and

while holding the storage medium between the first unit and the second unit, fixing the storage medium and at least one of the first unit and the second unit by rotating the storage medium and the one relatively to each other about the through hole.

The “storage medium apparatus” includes not only a finished apparatus which uses a storage medium to perform storage like a magnetic storage apparatus but also a partial apparatus into which the storage medium is incorporated during the step of manufacturing the finished apparatus. This point is applied also in the following.

In the method of manufacturing a storage medium apparatus according to the present invention, the storage medium apparatus is manufactured such that the storage medium is sandwiched to be fixed between the abutment face of the first unit made of a soft metal material and the abutment face of the second unit made of a soft metal material. Thus, even when foreign materials enter between the storage medium and the first unit or between the storage medium and the second unit, the foreign materials dent the soft metal material. Here, since the soft metal is resistant to heat generated when the storage medium apparatus is in an active state and has a small hardness among metals, it is suitable as a material which can be dented by foreign materials. Further, at least one of the first unit and the second unit as well as the storage medium are relatively rotated about the through hole so that the soft metal material can be reliably dented by the foreign materials sandwiched between the storage medium and the soft metal material.

Thus, in the storage medium apparatus manufactured by the method of manufacturing a storage medium apparatus of the present invention, since the storage medium is kept flat even when the foreign materials are present, a distortion hardly occurs in the storage medium, thereby avoiding the concentration of the defect areas.

The present invention also provides a method of manufacturing a storage medium apparatus in which a storage medium which stores data is incorporated according to a second aspect, including:

creating a first abutment face of a first unit, which has an insertion section to be inserted into a though hole of the storage medium and a face opposed to a surface of the storage medium and spreading around the insertion section, by providing a soft metal material at the face of the first unit;

disposing the storage medium onto the insertion section such that the surface of the storage medium abuts on the first abutment face of the first unit;

creating a second abutment face of a second unit, which has a face opposed to a surface of the storage medium opposite to the surface abutting the first abutment face of the first unit, by providing a soft metal material at the face of the second unit; and

fixing the storage medium by abutting the second unit against the surface of the storage medium opposite to the surface abutting the first abutment face of the first unit, and holding the storage medium between the first unit and the second unit.

The storage medium apparatus is manufactured such that the soft metal material suitable for a material of the member which can be dented by foreign materials is provided at the abutment face of the first unit and the abutment face of the second unit so that a distortion hardly occurs, thereby avoiding the concentration of the defect areas.

In the method of manufacturing a storage medium apparatus according to the first aspect of the present invention and the method of manufacturing a storage medium apparatus according to the second aspect of the present invention, it is preferable that “the second unit is either of a penetration type that has a through hole into which the insertion section of the first unit is inserted and is sandwiched between the plural storage mediums while abutting on a surface of each storage medium, and a termination type that is fixed at a tip end of the insertion section of the first unit,

the step of disposing is a step of alternately disposing the storage medium and the second unit of the penetration type onto the first unit, and

the step of fixing is a step of fixing each of the storage mediums by holding the storage medium disposed onto the first unit and the second unit of the penetration type between the first unit and the second unit of the termination type, and clamping the first unit and the second unit of the termination type to each other.”

According to this additional feature, even when manufacturing the storage medium apparatus having plural storage mediums, the storage medium apparatus will be manufactured in which a distortion hardly occurs in each storage medium.

Further, in the method of manufacturing a storage medium apparatus according to the first aspect of the present invention and the method of manufacturing a storage medium apparatus according to the second aspect of the present invention, it is also preferable that “each of the abutment faces of the first unit and the second unit is made of a soft metal material softer than a substrate material forming the storage medium.”

According to this additional feature, since the foreign materials easily dent the soft metal material before a distortion occurs in the storage medium, flatness of the storage medium is kept, and even when the foreign materials are present, they hardly affect information recording/reproducing.

Furthermore, in the method of manufacturing a storage medium apparatus according to the first aspect of the present invention and the method of manufacturing a storage medium apparatus according to the second aspect of the present invention, it is also preferable that “the soft metal material used in the first unit and the second unit has a thickness within a range from 0.02 mm to 1.00 mm in the direction perpendicular to the abutment face.”

The thickness of the abutment face needs to be thicker than a typical size of a foreign material. The height of the storage medium apparatus in the direction perpendicular to the abutment face needs to be restricted to avoid size increase of the storage medium apparatus. When the thickness of the soft metal material ranges between 0.02 mm and 1.00 mm inclusive in the direction perpendicular to the abutment face, such conditions are easily met.

Further, in the method of manufacturing a storage medium apparatus according to the first aspect of the present invention, it is also preferable that “the fixing step is a step where when holding the storage medium between the second unit and the first unit, the storage medium is sandwiched at a pressure of about 0.5 kgf/cm²”.

According to this additional feature, the storage medium can be tightly sandwiched without causing damage to the storage medium.

The present invention also provides a storage medium apparatus in which a storage medium which stores data is incorporated, including:

a first unit which comprises an insertion section inserted into a through hole of the storage medium and an abutment face made of a soft metal material and spreading like a plate around the insertion section while abutting a surface of the storage medium; and

a second unit which comprises an abutment face made of a soft metal material and abutting a surface of the storage medium opposite to the surface abutting the abutment face of the first unit.

The storage medium apparatus according to the present invention employs a soft metal material suitable for a material of the member which can be dented by foreign materials as a material of the abutment face of the first unit and the abutment face of the second unit so that a distortion hardly occurs in the storage medium, thereby preventing the concentration of the defect areas.

According to the present invention, occurrence of a distortion can be prevented.

### BRIEF DESCRIPTION OF THE DRAWINGS

FIG. 1 shows a distribution of defects of a substantially flat magnetic disk;

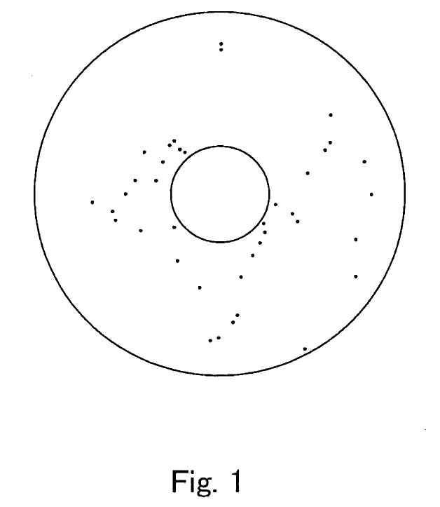

FIG. 2 shows a distribution of defects of a magnetic disk where a distortion occurs;

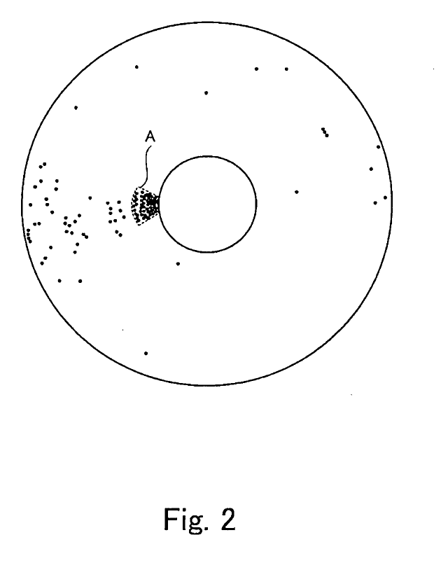

FIG. 3 is a plan view of a hard disk drive (HDD) corresponding to one example of the storage medium apparatus according to the present invention;

FIG. 4 is a side cross-section view of the hard disk drive (HDD) of FIG. 3;

FIG. 5 is an enlarged cross-section view of a magnetic disk, clamp, spacer and hub shown in FIG. 4; and

FIG. 6 is a flowchart showing a method of manufacturing the HDD.

### DETAILED DESCRIPTION OF THE INVENTION

Hereinafter, an embodiment according to the present invention will be described.

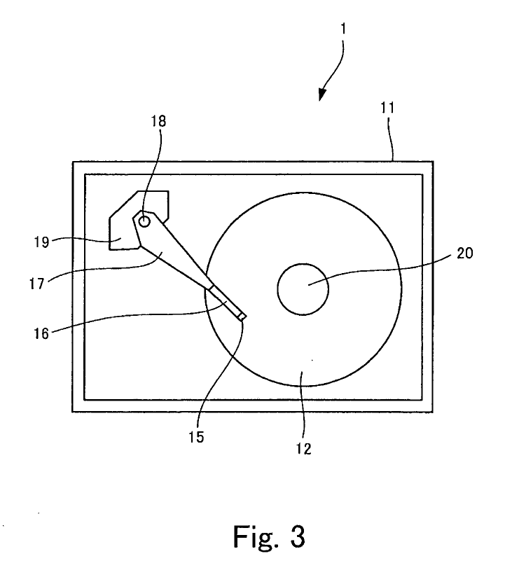

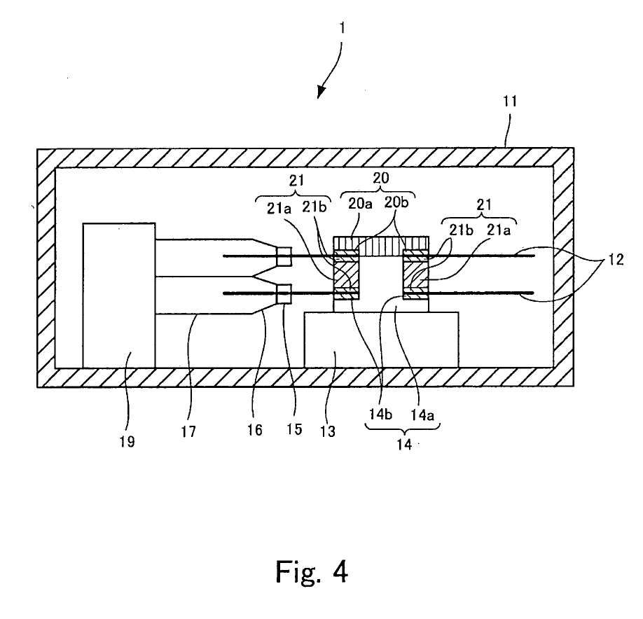

FIG. 3 is a plan view of a hard disk drive (HDD) corresponding to one example of a storage medium apparatus according to the present invention, and FIG. 4 is a side cross-section view of the hard disk drive (HDD).

The hard disk drive (HDD) 1 shown in the figures is provided with a disk-shaped magnetic disk 12 having a through hole at its center as shown in FIG. 3 inside a housing 11. The magnetic disk 12 corresponds to one example of the storage medium according to the present invention.

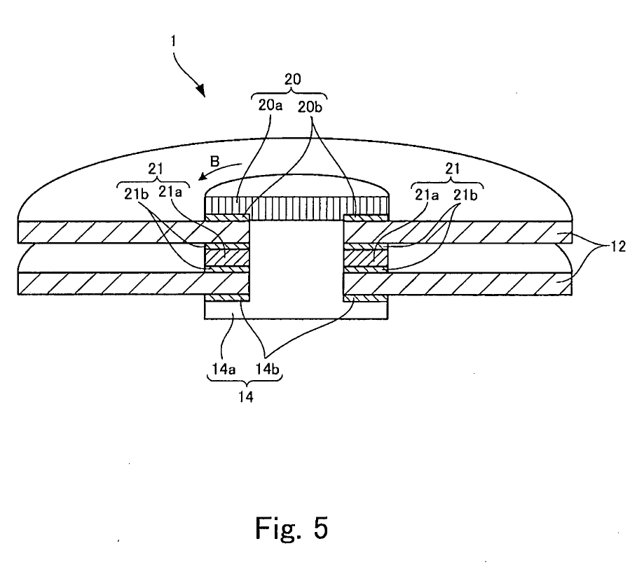

As shown in FIG. 4, the HDD 1 is provided with two magnetic disks 12, and a spacer 21 which separates the two magnetic disks 12 at a predetermined distance is provided between the two magnetic disks 12. In a state where the two magnetic disks are separated by the spacer 21 at a predetermined distance, the through holes of the two magnetic disks 12 are inserted with a hub body 14a of a hub 14 and a tip end face of the inserted hub body 14a is fixed to a clamp 20. The hub 14 is composed of the hub body 14a and a first protrusion absorbing section 14b that is provided on the hub body 14a and is pressed against the lower magnetic disk 12 as shown in FIG. 4. Similarly, the clamp 20 is composed of a clamp body 20a and a second protrusion absorbing section 20b that is provided on the clamp body 20a and is pressed against the upper magnetic disk 12 as shown in FIG. 5. The spacer 21 is composed of a spacer body 21a and a third protrusion absorbing section 21b which is provided at the upper and lower faces of the spacer body 21a, respectively and is pressed against the two magnetic disks 12, respectively. The first protrusion absorbing section 14b, second protrusion absorbing section 20b and third protrusion absorbing section 21b are made of a soft metal material in order to avoid a distortion in the magnetic disk 12 due to foreign materials that become protrusions upon entering between the magnetic disk 12 and the hub 14, between the magnetic disk 12 and the clamp 20 or between the magnetic disk 12 and the spacer 21. The three protrusion absorbing sections will be described below in detail. Here, the hub 14 corresponds to one example of the first unit according to the present invention, the clamp 20 corresponds to one example of the second unit of a termination type according to the present invention, and the spacer 21 corresponds to one example of the second unit of a penetration type according to the present invention. A part of the hub body 14a into which the two magnetic disks 12 are inserted corresponds to one example of the insertion section according to the present invention.

The hub 14 can rotate in response to a drive force of a drive motor 13, and the two magnetic disks 12, the clamp 20 and the spacer 21 rotate about the center of the disk-shaped magnetic disk 12 shown in FIG. 3 integrally with the hub 14 along with the rotation of the hub 14.

As shown in FIG. 4, four floating head sliders 15 are provided near the respective upper and lower faces of the two magnetic disks 12 inside the housing 11 of the HDD 1, respectively. Each floating head slider 15 is mounted with a hybrid recording/reproducing head composed of a magnetoresistance effect reproducing head such as so-called GMR (gigantic magnetoresistance) head or TMR (tunnel effect magnetoresistance) head and a recording head such as so-called inductive head. The floating head sliders 15 are supported by a carriage arm 17 via a suspension 16. The carriage arm 17 is a member which can rotate about an arm shaft 18 shown in FIG. 3 in response to a drive force from an actuator 19.

In the HDD 1, information is recorded into the magnetic disk 12 and the information recorded into the magnetic disk 12 is reproduced. When recording and reproducing the information, the carriage arm 17 is first driven by the actuator 19 having a magnetic circuit, and then the floating head sliders 15 are positioned at desired tracks on the rotating magnetic disk 12. The magnetic head is disposed at the tip end of the floating head slider 15 and the magnetic head sequentially approach each 1-bit area arranged in each track of the magnetic disk 12 along with the rotation of the magnetic disk 12. When recording the information, an electric recording signal is input into the magnetic head approaching the magnetic disk 12 in this way. The magnetic head applies a magnetic field to each 1-bit area in response to the input recording signal, and records the information carried by the recording signal as the magnetization direction of each 1-bit area thereof. When reproducing the information, the magnetic head generates an electric reproducing signal according to a magnetic field generated from each magnetization, thereby extracting the information recorded as the magnetization direction of each 1-bit area.

Next, the protrusion absorbing section pressing against the magnetic disk 12 will be described.

FIG. 5 is an enlarged cross-section view of the magnetic disk, clamp, spacer and hub shown in FIG. 4.

As shown in FIG. 5, the HDD 1 is configured such that the two magnetic disks 12 contact with any one of the protrusion absorbing sections at the upper and lower disk surfaces and does not contact directly with any of the clamp body 20a, the spacer body 21a and the hub body 14a at the upper and lower disk surfaces.

If the HDD is configured such that the protrusion absorbing section is not present and the magnetic disks, the clamp body, the spacer body and the hub body are made to directly contact the disk surface, when foreign materials enter between the magnetic disk and any of the clamp body, the spacer body and the hub body at the time of assembling the HDD, the foreign materials become slight protrusions that contact the magnetic disk at the pressed face when the magnetic disk is pressed against any member. When the disk is pressed in a state where foreign materials are present, stress occurs in the magnetic disk substrate having a large thickness and hardness so that a distortion occurs in the magnetic disk where the foreign materials exist. As a result, flatness of the storage medium is lost so that defect areas where information recording or reproducing is disabled appear near the distortion intensively (since an under layer, a magnetic layer, a protection layer and the like formed on the disk substrate have the thickness of about several to several tens nm, an affect due to these layers can be ignored).

As shown in FIG. 5, the first protrusion absorbing section 14b, the second protrusion absorbing section 20b and the third protrusion absorbing section 21b are provided between the magnetic disk 12 and the hub body 14a, between the magnetic disk 12 and the clamp body 20a and between the magnetic disk 12 and the spacer body 21, respectively, so that foreign materials dent each protrusion absorbing section at the pressed face where each protrusion absorbing section is pressed against the magnetic disk 12 and the disk substrate is kept flat even if the foreign materials are present. Thus, since the stress does not occur in the disk substrate, a distortion hardly occurs in the magnetic disk, thereby preventing the defect areas from intensively appearing.

The nature of the protrusion absorbing section is required to be soft enough to easily absorb a protrusion as described above, and further is required to be resistant to heat generated at the time of the rotation of the magnetic disk 12. Thus, the present embodiment employs a soft metal having a small hardness among metals as the material of the first protrusion absorbing section 14b, the second protrusion absorbing section 20b and the third protrusion absorbing section 21b. Such a soft metal includes gold, silver, copper, lead, tin, zinc or the like, for example. A soft metal of the same kind may be employed as the material of the first protrusion absorbing section 14b, the second protrusion absorbing section 20b and the third protrusion absorbing section 21b, or different types of soft metals may be employed.

Further, in the present embodiment, each protrusion absorbing section is made of a soft metal softer than the disk substrate of the magnetic disk 12 such that the protrusion is absorbed in each protrusion absorbing section before protrusive foreign materials cause a distortion in the magnetic disk 12.

The thickness in the vertical direction of each protrusion absorbing section in FIG. 5 needs to be thicker than a typical size of a foreign material. The height of the HDD 1 (the height in the vertical direction in FIG. 5) needs to be restricted such that an increase in size of the HDD 1 can be avoided. In order to meet such conditions, in the present embodiment, the protrusion absorbing section having a thickness between 0.02 mm and 1.00 mm inclusive is provided as each protrusion absorbing section.

The diameters of the clamp 20 and the hub 14 are designed to be smaller than the outer diameter of the magnetic disk 12 in order not to reach each storage area of the magnetic disk 12 where the information is stored. Specifically, in the case of a 2.5-inch magnetic disk (diameter of 65 mm), the diameter of the through hole at the center of the magnetic disk 12 is about 20 mm, and the second protrusion absorbing section 20b of the clamp 20 and the first protrusion absorbing section 14b of the hub 14 are abutted on a ring-shaped area having a width of about 1 to 2 mm around the through hole. By way of explanation using the cross-section view shown in FIG. 5, the area where the second protrusion absorbing section 20b of the clamp 20 and the first protrusion absorbing section 14b of the hub 14 are abutted is provided at each of both sides of the through hole for about 1 to 2 mm. The storage area is set at the outer periphery of the area such that a necessary recording capacity can be secured. Similarly, the outer diameter of the spacer 21 is also set to be smaller than the outer diameter of the magnetic disk 12, and may be the same as or different from the diameters of the clamp 20 and the hub 14.

Hereinafter, the method of manufacturing the HDD 1 will be described focusing on the arrangement of the magnetic disks 12, the clamp 20, the spacer 21 and the hub 14. Although the HDD 1 of FIG. 5 has the two magnetic disks 12, general description will be made as to a case where an arbitrary number of magnetic disks 12 are provided.

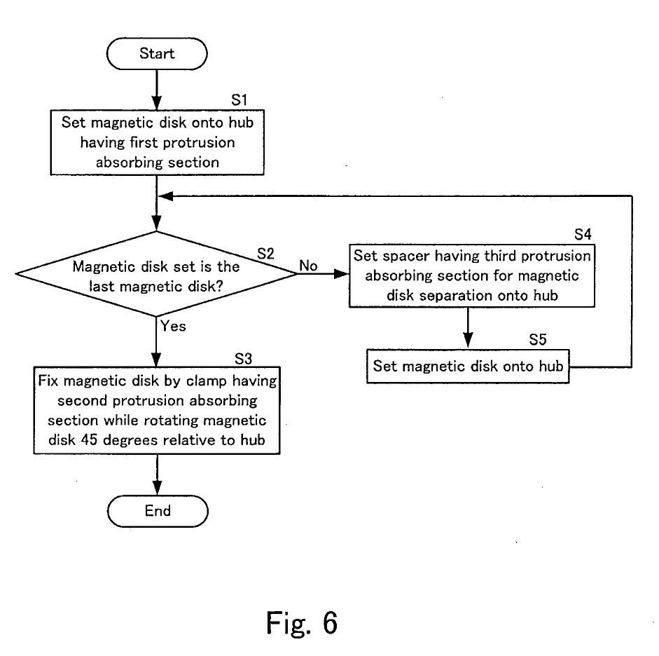

FIG. 6 is a flowchart showing a method of manufacturing the HDD.

Thin films each made of a soft metal between 5 μm and 20 μm inclusive are laminated and affixed at a part of the hub body 14a shown in FIG. 5 which projects in the horizontal direction so that the first protrusion absorbing section 14b is created. By laminating the thin films in this way, a slight gap is formed between the metal thin films, thereby effectively absorbing protrusions of foreign materials. Similarly, thin films each made of a soft metal between 5 μm and 20 μm inclusive are laminated and affixed on the face of the clamp body 20a and on both faces of the spacer body 21a shown in FIG. 5 so that the second protrusion absorbing section 20b and the third protrusion absorbing section 21b are created, respectively. The method for creating each protrusion absorbing section may employ a method for accumulating thin films made of a soft metal on the hub body 14a or a method for applying plating processing on the hub body 14a.

In this way, the hub 14 having the first protrusion absorbing section 14b, the clamp 20 having the second protrusion absorbing section 20b and the spacer 21 having the third protrusion absorbing section 21b are created.

Next, the hub body 14a is inserted into the though hole at the center of the first magnetic disk 12 (corresponding to the lower magnetic disk 12 shown in FIG. 5) so that the first magnetic disk 12 is set in the hub 14 (step S1). In this state, the lower face of the first magnetic disk 12 is contacted with the first protrusion absorbing section 14b. Next, a determination is made as to whether the set magnetic disk 12 is the last magnetic disk 12 (step S2). Since it is necessary to set the second and subsequent disks 12, the determination is No. Then the spacer 21 which separates the magnetic disks is set in the hub 14 such that the third protrusion absorbing section 21b provided at the lower face of the spacer 21 is made to contact with the first magnetic disk as shown in FIG. 5 (step S4). Then, the second magnetic disk 12 is set in the hub 14 so as to contact with the third protrusion absorbing section 21b provided on the upper face of the spacer 21 (step S5). Subsequently, the processing returns to step S2, where a determination is made again as to whether the set magnetic disk 12 is the last magnetic disk 12. The determination is made as No in step S2 until all the magnetic disks 12 are set, and the processings of step S4 and step S5 are repeated. When all the magnetic disks 12 are set (step S2; Yes), the clamp 20 is fixed on the hub body 14a such that the second protrusion absorbing section 20b is made to contact the last-set magnetic disk (step S3). At the time of this fixing processing, a pressure is applied to the magnetic disks already set such that the magnetic disks are sandwiched between the clamp 20 and the hub 14. The magnitude of the pressure at this time is on the order of 0.5 kgf/cm², and this degree of pressure does not cause damage in the magnetic disks so that the several magnetic disks can be tightly sandwiched. Further, at the time of this fixing processing, in a state where the clamp 20, the hub 14 and the spacer 21 are maintained so as not to rotate about the hub body 14a which is inserted into the though hole of the magnetic disks, the fixing processing is performed while the magnetic disks are rotated about the center shaft about 45 degrees in the direction of arrow B in FIG. 5. The fixing processing is performed while rotating the magnetic disk in this way, so that foreign materials sandwiched between the magnetic disks and any of the clamp 20, the spacer 21 and the hub 14 can dent the protrusion absorbing section. Consequently, a distortion in the magnetic disk can be accurately prevented.

What is claimed is:

1. A method of manufacturing a storage medium apparatus in which a storage medium which stores data is incorporated, comprising the steps of:
disposing the storage medium onto a first unit having an insertion section to be inserted into a through hole of the storage medium and an abutment face made of a soft metal material and spreading around the insertion section, such that the insertion section is inserted into the through hole of the storage medium and the abutment face abuts on a surface of the storage medium;
abutting an abutment face of a second unit on a surface of the storage medium opposite to the surface abutting the abutment face of the first unit, the abutment face of the second unit being made of a soft metal material; and
while holding the storage medium between the first unit and the second unit, fixing the storage medium and at least one of the first unit and the second unit by rotating the storage medium and the one relatively to each other about the through hole.

2. A method of manufacturing a storage medium apparatus in which a storage medium which stores data is incorporated, comprising the steps of:
creating a first abutment face of a first unit, which has an insertion section to be inserted into a though hole of the storage medium and a face opposed to a surface of the storage medium and spreading around the insertion section, by providing a soft metal material at the face of the first unit;
disposing the storage medium onto the insertion section such that the surface of the storage medium abuts on the first abutment face of the first unit;
creating a second abutment face of a second unit, which has a face opposed to a surface of the storage medium opposite to the surface abutting the first abutment face of the first unit, by providing a soft metal material at the face of the second unit; and
fixing the storage medium by abutting the second unit against the surface of the storage medium opposite to the surface abutting the first abutment face of the first unit, and holding the storage medium between the first unit and the second unit.

3. The method of manufacturing a storage medium apparatus according to claim 1, wherein:
the second unit is either of a penetration type that has a through hole into which the insertion section of the first unit is inserted and is sandwiched between the plural storage mediums while abutting on a surface of each storage medium, and a termination type that is fixed at a tip end of the insertion section of the first unit,
the step of disposing is a step of alternately disposing the storage medium and the second unit of the penetration type onto the first unit, and
the step of fixing is a step of fixing each of the storage mediums by holding the storage medium disposed onto the first unit and the second unit of the penetration type between the first unit and the second unit of the termination type, and clamping the first unit and the second unit of the termination type to each other.

4. The method of manufacturing a storage medium apparatus according to claim 2, wherein:
the second unit is either of a penetration type that has a through hole into which the insertion section of the first unit is inserted and is sandwiched between the plural storage mediums while abutting on a surface of each storage medium, and a termination type that is fixed at a tip end of the insertion section of the first unit,
the step of disposing is a step of alternately disposing the storage medium and the second unit of the penetration type onto the first unit, and
the step of fixing is a step of fixing each of the storage mediums by holding the storage medium disposed onto the first unit and the second unit of the penetration type between the first unit and the second unit of the termination type, and clamping the first unit and the second unit of the termination type to each other.

5. The method of manufacturing a storage medium apparatus according to clam 1, wherein each of the abutment faces of the first unit and the second unit is made of a soft metal material softer than a substrate material forming the storage medium.

6. The method of manufacturing a storage medium apparatus according to clam 2, wherein each of the abutment faces of the first unit and the second unit is made of a soft metal material softer than a substrate material forming the storage medium.

7. The method of manufacturing a storage medium apparatus according to claim 1, wherein the soft metal material used in the first unit and the second unit has a thickness within a range from 0.02 mm to 1.00 mm in the direction perpendicular to the abutment face.

8. The method of manufacturing a storage medium apparatus according to claim 2, wherein the soft metal material used in the first unit and the second unit has a thickness within a range from 0.02 mm to 1.00 mm in the direction perpendicular to the abutment face.

9. The method of manufacturing a storage medium apparatus according to claim 1, wherein the step of fixing is a step of clamping the storage medium sandwiched between the second unit and the first unit at a pressure of about 0.5 kgf/cm².

10. A storage medium apparatus in which a storage medium which stores data is incorporated, comprising:
a first unit which comprises an insertion section inserted into a through hole of the storage medium and an abutment face made of a soft metal material and spreading like a plate around the insertion section while abutting a surface of the storage medium; and
a second unit which comprises an abutment face made of a soft metal material and abutting a surface of the storage medium opposite to the surface abutting the abutment face of the first unit.
